(19) United States
(12) Patent Application Publication
(10) Pub. No.: US 2021/0292684 A1
(43) Pub. Date: Sep. 23, 2021

(54) METHOD OF DOSING LAUNDRY COMPOSITION

(71) Applicant: Conopco, Inc., d/b/a UNILEVER, Englewood Cliffs, NJ (US)

(72) Inventor: Bastien Paul HAMOUNIC, London (GB)

(73) Assignee: Conopco, Inc., d/b/a UNILEVER, Englewood Cliffs, NJ (US)

(21) Appl. No.: 17/267,697

(22) PCT Filed: Jul. 24, 2019
(86) PCT No.: PCT/EP2019/069969

§ 371 Date: Feb. 10, 2021

(30) Foreign Application Priority Data
Aug. 15, 2018 (EP) 18189178.9

(51) Int. Cl. C11D 3/50; C11D 11/00; C11D 1/83; C11D 1/835; C11D 3/37; C11D 3/40; C11D 3/48

(52) U.S. Cl. CPC C11D 3/505; C11D 11/0017; C11D 1/83; C11D 1/72; C11D 3/373; C11D 3/40; C11D 3/48; C11D 1/835

(57) ABSTRACT

A method of delivering a laundry serum composition into the wash or rinse cycle, comprising the steps of: Pouring a laundry liquid or powder into a washing machine drawer, drum or a dosing shuttle Pouring a laundry serum composition on top of the laundry liquid or powder, wherein the serum comprises: 0.5 to 15 w.t. % non-ionic surfactant; 0.5 to 20 w.t. % perfume ingredients; and water.

### FIELD OF THE INVENTION

The present invention relates to a method of delivering improved perfume benefits during the laundry process.

### BACKGROUND OF THE INVENTION

Fragrance is an important aspect of the laundry process. Consumers often associate fragrance with cleanliness or simply enjoy the smell; accordingly, many laundry products comprise perfumes. However, the desired quantity of perfume varies from consumer to consumer. Consequently, ancillary fragrance products are required to allow flexibility to consumers.

### SUMMARY OF THE INVENTION

In a first aspect of the present invention is provided a method of delivering a laundry serum composition into the wash or rinse cycle, comprising the steps of:
i. Pouring a laundry liquid or powder into a washing machine drawer, drum or a dosing shuttle
ii. Pouring a laundry serum composition on top of the laundry liquid or powder

wherein the serum comprises:
a. 0.5 to 15 w.t. % Non-ionic surfactant;
b. 0.5 to 20 w.t. % Perfume ingredients; and
c. Water.

In a second aspect of the present invention is provided a use of the method, to deliver perfume to fabric during the laundry process.

### DETAILED DESCRIPTION OF THE INVENTION

The term ‘laundry liquid’ is used to refer to traditional liquids used in the laundry process, particularly liquid laundry detergents and liquid laundry fabric conditioners/softener.

The term ‘laundry serum’ is used to refer to a specific format of laundry product. This is a liquid product which is used in addition to the laundry detergent and/or the fabric conditioner to provide an additional or improved benefit to the materials in the wash or rinse cycle. A serum is defined by its physical interaction with laundry liquids. A serum will float on the laundry liquid with which it is designed to be used. A serum may also be referred to as a liquid ancillary composition.

Throughout this specification density is measured by weighing a known volume of sample using a ‘Sheen’ density cup with lid on a 4 figure balance.

Throughout this specification viscosity measurements were carried out at 25° C., using a 4 cm diameter 2° cone and plate geometry on a DHR-2 rheometer ex. TA instruments.

In detail, all measurements were conducted using a TA-Instruments DHR-2 rheometer with a 4 cm diameter 2 degree angle cone and plate measuring system. The lower Peltier plate was used to control the temperature of the measurement to 25° C. The measurement protocol was a ‘flow curve’ where the applied shear stress is varied logarithmically from 0.01 Pa to 400 Pa with 10 measurement points per decade of stress. At each stress the shear strain rate is measured over the last 5 seconds of the 10 second period over which the stress is applied with the viscosity at that stress being calculated as the quotient of the shear stress and shear rate.

For those systems which exhibit a low shear viscosity plateau over large shear stress ranges, to at least 1 Pa, the characteristic viscosity is taken as being the viscosity at a shear stress of 0.3 Pa. For those systems where the viscosity response is shear thinning from low shear stress the characteristic viscosity is taken as being the viscosity at a shear rate of 21 s-1.

### Method of Delivery

One aspect of the present invention is a method of delivering the laundry perfume serum into the wash or rinse cycle.

The method of delivering a laundry perfume serum composition into the wash or rinse cycle, comprises the steps of:
a. Pouring a laundry liquid or powder into a washing machine drawer, drum or a dosing shuttle
b. Pouring a laundry serum composition according to any preceding claim on top of the laundry liquid or powder

By drawer it as meant any one of the compartments in the washing machine drawer. By dosing ball is meant any form of container which would usually hold a laundry detergent composition and be placed directly in a washing machine.

Preferably a laundry liquid or powder is poured into a washing machine drawer or a dosing ball, and then the serum is poured on top of the laundry liquid or powder in the drawer or dosing ball.

Pouring the laundry serum on top of the laundry liquid or powder provides the benefit that the laundry liquid or powder carries the serum into the wash or rinse with mixing with the two compositions. Preferably the serum is used in conjunction with a laundry liquid.

Preferably the serum is added to the laundry process in a volume of 2-50 ml, more preferably a volume of ml 2-30 ml, most preferably 2-20 ml. This volume delivers a desirable level of perfume into the wash in a volume which the consumer can easily dose.

### Serum Composition

The serum composition is an aqueous composition. The perfume serum comprises perfume, non-ionic surfactant and water.

### Non-Ionic Surfactants

The serum composition of the present invention comprises non-ionic surfactant. Preferably the serum comprises 0.5 to 15 w.t. % non-ionic surfactant, more preferably 0.5 to 10 w.t. % non-ionic surfactant, most preferably 0.5 to 6 w.t. % non-ionic surfactant. The correct amount of non-ionic surfactant is important to achieve the desired delivery of perfume. The serum requires sufficient surfactant to solubilise free perfume, however too much surfactant will interfere with the action of the laundry liquid or powder with which it is used and will prevent fragrance release due to insufficient dilution.

The non-ionic surfactants will preferably have an HLB value of 12 to 20, more preferably 14 to 18.

Examples of non-ionic surfactant materials include: ethoxylated materials, polyols such as polyhydric alcohols and polyol esters, alkyl polyglucosides, EO-PO block copolymers (Poloxamers). Preferably, the non-ionic surfactant is selected from ethoxylated materials.

Preferred ethoxylated materials include: fatty acid ethoxylates, fatty amine ethoxylates, fatty alcohol ethoxylates, nonylphenol ethoxylates, alkyl phenol ethoxylate, amide ethoxylates, Sorbitan(ol) ester ethoxylates, glyceride ethoxylates (castor oil or hydrogenated castor oil ethoxylates) and mixtures thereof.

More preferably, the non-ionic surfactant is selected from ethoxylated surfactants having a general formula:

R₁O(R₂O)ₓH

R₁=hydrophobic moiety.

R₂=C₂H₄ or mixture of C₂H₄ and C₃H₆ units

x=4 to 120

R1 preferably comprises 8 to 25 carbon atoms and mixtures thereof, more preferably 10 to 20 carbon atoms and mixtures thereof most preferably 12 to 18 carbon atoms and mixtures thereof. Preferably, R is selected from the group consisting of primary, secondary and branched chain saturated and/or unsaturated hydrocarbon groups comprising an alcohol, carboxy or phenolic group. Preferably R is a natural or synthetic alcohol.

R2 preferably comprises at least 50% C2H4, more preferably 75% C2H4, most preferably R2 is C2H4.

x is preferably 8 to 90 and most preferably 10 to 60.

Examples of commercially available, suitable non-ionic surfactants include: Genapol C200 ex. Clariant and Eumulgin C040 ex. BASF.

### Perfumes

The serum of the present invention comprises perfume ingredients. Perfume ingredients may be provided either as a free oil and/or in a microcapsule.

The serum of the present invention may comprise one or more perfume compositions. The perfume compositions may be in the form of a mixture of free perfumes compositions, a mixture of encapsulated perfume compositions or a mixture of encapsulated and free oil perfume compositions.

Preferably the serums of the present invention comprise 0.5 to 20 w.t. % perfume ingredients, more preferably 1 to 15 w.t. % perfume ingredients, most preferably 2 to 10 w.t. % perfume ingredients.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Particularly preferred perfume components are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume ingredients may be applied.

Free perfume may preferably be present in an amount from 0.01 to 20% by weight, more preferably from 0.05 to 10% by weight, even more preferably from 0.1 to 6.0%, most preferably from 0.5 to 6.0% by weight, based on the total weight of the serum composition.

When perfume components are in a microcapsule, suitable encapsulating material, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume ingredients may be applied.

Encapsulated perfume may preferably be present in an amount from 0.01 to 20 by weight, more preferably from 0.05 to 10% by weight, even more preferably from 0.1 to 6.0%, most preferably from 0.5 to 6.0 % by weight, based on the total weight of the serum composition.

### Structurant

If the serum comprises microcapsules, a structurant may be required, non-limiting examples of suitable structurants include: pectine, alginate, arabinogalactan, carageenan, gellan gum, polysaccharides such as xanthum gum, guar gum, acrylates/acrylic polymers, water-swellable clays, fumed silicas, acrylate/aminoacrylate copolymers, and mixtures thereof.

Preferred dispersants herein include those selected from the group consisting of acrylate/acrylic polymers, gellan gum, fumed silicas, acrylate/aminoacrylate copolymers, water-swellable clays, polysaccharides such as xanthum gum and mixtures thereof. Most preferably the structurant is selected from polysaccharides such as xanthum gum, acrylate/acrylic polymers, acrylate/aminoacrylate copolymers, and water-swellable clays. Most preferred structurants are polysaccharides such as xanthum gum.

When present, a structurant is preferably present in an amount of 0.001-10 w.t. % percent, preferably from 0.005-5 w.t. %, more preferably 0.01-3 w.t. %.

### Surfactant

The serum composition of the present invention is not a traditional laundry detergent or fabric conditioning composition. The present invention preferably comprises low levels or no surfactants anionic or cationic surfactant.

The liquid ancillary composition of the present invention preferably comprises less than 2 w.t. % anionic and cationic surfactant, more preferably less than 1 w.t. % surfactant, even more preferably less than 0.85 w.t. % anionic and cationic surfactant and most preferably less than 0.5 w.t. % anionic and cationic surfactant. The composition can be completely free of anionic and cationic surfactants.

In other words, the compositions preferably comprises 0 to 2 w.t. % anionic and cationic surfactant, more preferably, 0 to 1 w.t. % anionic and cationic surfactant, even more preferably 0 to 0.85 w.t. % and most preferably 0 to 0.5 w.t. % anionic and cationic surfactant. The composition can be completely free of anionic and cationic surfactant.

### Rheology Modifier

In some embodiments of the present invention, the serum of the present invention may comprise rheology modifiers. These may be inorganic or organic, polymeric or non polymeric. A preferred type of rheology modifiers are salts.

### Preservatives

The serum composition of the present invention preferably comprises preservatives. Preservatives are preferably present in an amount of 0.001 to 1 w.t. % of the composition. More Preferably 0.005 to 0.5 w.t %, most preferably 0.01 to 0.1 w.t. % of the composition.

Preservatives can include anti-microbial agents such as isothiazolinone-based chemicals (in particular isothiazol-3-one biocides) or glutaraldehyde-based products. Examples of suitable preservatives include Benzisothiazoline, Cloro-methyl-isothiazol-3-one, Methyl-isothiazol-3-one and mixtures thereof. Suitable preservatives are commercially available as Kathon CG ex. Dow and Proxel ex Lonza.

### Additional Benefit Agents

It may be desirable for the perfume serums of the present invention to deliver more than one benefit agent to laundered fabrics. Additional benefit agents may be free in the serum or they may be encapsulated. Suitable encapsulating materials are outlined above in relation to perfumes. Examples of suitable benefit agents include:
malodour agents for example: uncomplexed cyclodextrin; odor blockers;
reactive aldehydes; flavanoids; zeolites; activated carbon; and mixtures thereof
dye transfer inhibitors
shading dyes
silicone oils, resins, and modifications thereof such as linear and cyclic polydimethylsiloxanes, amino-modified, allcyl, aryl, and alkylaryl silicone oils, which preferably have a viscosity of greater than 50,000 cst;
insect repellents
organic sunscreen actives, for example, octylmethoxy cinnamate;
antimicrobial agents, for example, 2-hydroxy-4,2,4-trichlorodiphenylether;
ester solvents; for example, isopropyl myristate;
lipids and lipid like substance, for example, cholesterol;
hydrocarbons such as paraffins, petrolatum, and mineral oil
fish and vegetable oils;
hydrophobic plant extracts;
waxes;
pigments including inorganic compounds with hydrophobically-modified surface and/or dispersed in an oil or a hydrophobic liquid, and;
sugar-esters, such as sucrose polyester (SPE).

A particularly preferred additional benefit agent is silicone. Use of a silicone in the fragranced serum compositions according to the method of the present invention improves the softening effect of the silicone.

Silicone may be present at a level selected from: less than 10%, less than 8%, and less than 6%, by weight of the serum composition. Silicone may be present at a level selected from: more than 0.5%, more than 1%, and more than 1.5%, by weight of the serum composition. Suitably silicone is present in the serum composition in an amount selected from the range of from about 0.5% to about 10%, preferably from about 1% to about 8%, more preferably from about 1.5 to about 6%, by weight of the serum composition.

Silicones and their chemistry are described in, for example in The Encyclopaedia of Polymer Science, volume 11, p765.

Silicones suitable for the present invention are fabric softening silicones. Non-limiting examples of such silicones include:
Non-functionalised silicones such as polydimethylsiloxane (PDMS),
Functionalised silicones such as alkyl (or alkoxy) functionalised, alkylene oxide functionalised, amino functionalised, phenyl functionalised, hydroxy functionalised, polyether functionalised, acrylate functionalised, siliconhydride functionalised, carboxy functionalised, phosphate functionalised, sulphate functionalised, phosphonate functionalised, sulphonic functionalised, betaine functionalised, quarternized nitrogen functionalised and mixtures thereof.
Copolymers, graft co-polymers and block co-polymers with one or more different types of functional groups such as alkyl, alkylene oxide, amino, phenyl, hydroxy, polyether, acrylate, siliconhydride, carboxy, phosphate, sulphonic, phosphonate, betaine, quarternized nitrogen and mixtures thereof.

Suitable non-functionalised silicones have the general formula:

R1—Si(R3)₂—O—[—Si(R3)₂—O—]ₓ—Si(R3)₂—R2

R1=hydrogen, methyl, methoxy, ethoxy, hydroxy, propoxy, and aryloxy group.

R2=hydrogen, methyl, methoxy, ethoxy, hydroxy, propoxy, and aryloxy group.

R3=alkyl, aryl, hydroxy, or hydroxyalkyl group, and mixtures thereof

Suitable functionalised silicones may be anionic, cationic, or non-ionic functionalised silicones.

The functional group(s) on the functionalised silicones are preferably located in pendent positions on the silicone i.e. the composition comprises functionalised silicones wherein the functional group(s) are located in a position other than at the end of the silicone chain. The terms ‘terminal position’ and ‘at the end of the silicone chain’ are used to indicate the terminus of the silicone chain.

When the silicones are linear in nature, there are two ends to the silicone chain. In this case the anionic silicone preferably contains no functional groups located on a terminal position of the silicone.

When the silicones are branched in nature, the terminal position is deemed to be the two ends of the longest linear silicone chain. Preferably no functional group(s) are located on the terminus of the longest linear silicone chain.

Preferred functionalised silicones are those that comprise the anionic group at a mid-chain position on the silicone. Preferably the functional group(s) of the functionalised silicone are located at least five Si atoms from a terminal position on the silicone. Preferably the functional groups are distributed randomly along the silicone chain.

For best performance, it is preferred that the silicone is selected from: anionic functionalised silicone, non-functionalised silicone; and mixtures thereof. More preferably, the silicone is selected from: carboxy functionalised silicone; amino functionalised silicone; polydimethylsiloxane (PDMS) and mixtures thereof. Preferred features of each of these materials are outlined herein.

A carboxy functionalised silicone may be present as a carboxylic acid or an carbonate anion and preferably has a carboxy group content of at least 1 mol % by weight of the silicone polymer, preferably at least 2 mol %. Preferably the carboxy group(s) are located in a pendent position, more preferably located at least five Si atoms from a terminal position on the silicone. Preferably the caboxy groups are distributed randomly along the silicone chain. Examples of suitable carboxy functional silicones include FC 220 ex. Wacker Chemie and X22-3701E ex. Shin Etsu.

An amino functionalised silicone means a silicone containing at least one primary, secondary or tertiary amine group, or a quaternary ammonium group. The primary, secondary, tertiary and/or quaternary amine groups are preferably located in a pendent position, more preferably located at least five Si atoms from a terminal position on the silicone. Preferably the amino groups are distributed randomly along the silicone chain. Examples of suitable amino functional silicones include FC222 ex. Wacker Chemie and EC218 ex. Wacker Chemie.

A polydimethylsiloxane (PDMS) polymer has the general formula:

R1—Si(CH3)₂—O—[—Si(CH3)2—O—]ₓ—Si(CH3)₂—R2

R1=hydrogen, methyl, methoxy, ethoxy, hydroxy, propoxy, and aryloxy group.

R2=hydrogen, methyl, methoxy, ethoxy, hydroxy, propoxy, and aryloxy group.

A suitable example of a PDMS polymer is E22 ex. Wacker Chemie.

Most preferably the silicone is an amino functionalised silicone as described above.

The molecular weight of the silicone polymer is preferably from 1,000 to 500,000, more preferably from 2,000 to 250,000 even more preferably from 5,000 to 200,000.

### Other Ingredients

The serums of the present invention may contain further optional laundry ingredients. Such ingredients include preservatives (e.g. bactericides), pH buffering agents, perfume carriers, hydrotropes, anti-redeposition agents, soil-release agents, polyelectrolytes, anti-shrinking agents, anti-wrinkle agents, anti-oxidants, sunscreens, anti-corrosion agents, drape imparting agents, anti-static agents, ironing aids, silicones, antifoams, colorants, shading dyes, pearlisers and/or opacifiers, natural oils/extracts, processing aids, e.g. electrolytes, hygiene agents, e.g. anti-bacterials and antifungals, thickeners and skin benefit agents.

### Physical Characteristics

The viscosity of the laundry composition is preferably 50 to 15000 mPa·s, more preferably 100 to 1000 mPa·s, most preferably 100 to 800 mPa·s. This viscosity provides the benefit that a laundry liquid can carry the serum into the laundry process.

Preferably the viscosity of the laundry serum composition is greater than the viscosity of a laundry liquid with which it is used, more preferably 100 mPa·s, most preferably 200 mPa·s greater than a laundry liquid with which it is used. The higher viscosity prevents mixing of the laundry serum composition and laundry liquid and provides the benefit that the entire serum composition is carried into the wash or rinse with the laundry liquid.

Preferably, the serum floats on a, laundry liquid with which it is used. By float it is meant that the serum will remain at the surface of the laundry liquid for a period of at least 5 minutes, preferably 10 minutes and most preferably at least 15 minutes. Floating provides the benefit the laundry liquid carries the serum into the laundry process.

To enable the serum to float, it is not essential that it is less dense than the laundry liquid with which it is being used, however it is preferred that the serum is less dense than the laundry liquid with which it is used. This density provides the benefit the laundry liquid carries the serum into the laundry process.

The laundry serum composition is preferably not miscible with a laundry liquid with which it is used. The in-admissibility prevents mixing of the laundry serum composition and laundry liquid and ensures maximum performance of the serum.

### Use of the Method

The method according to this invention can be used, to deliver perfume to fabric during the laundry process.

1) A method of delivering a laundry serum composition into the wash or rinse cycle, comprising the steps of:
i. Pouring a laundry liquid or powder into a washing machine drawer, drum or a dosing shuttle
ii. Pouring a laundry serum composition on top of the laundry liquid or powder
wherein the serum comprises:
a. 0.5 to 15 wt. % Non-ionic surfactant;
b. 0.5 to 20 wt. % Perfume ingredients; and
c. Water.

2) The method according to claim 1, wherein the viscosity of the laundry serum is 100-15000 mPa·s.

3) The method according to any proceeding claim 1, wherein 2-50 ml of the laundry serum composition is poured on top of a laundry liquid or powder.

4) The method according to claim 1, wherein the serum comprises perfume ingredients comprising free perfume and encapsulated perfumes.

5) The method according to claim 1, wherein the serum comprises an ethoxylated non-ionic surfactant.

6) The method according to claim 1 wherein the serum comprises a silicone.

7) The method according to claim 1, wherein the composition comprises less than 2 wt. % surfactant selected from anionic, cationic and mixtures thereof.

8) The method according to any preceding claim 1, wherein the serum is used with a laundry liquid.

9) The method according to claim 8, wherein the laundry serum composition has a viscosity greater than a laundry liquid or with which it is used.

10) The method according to claim 9, wherein viscosity of the serum is more than 300 Pa·s greater than a laundry liquid with which it is used.

11) The method according to claim 8, wherein the laundry serum floats on a laundry liquid with which it is used.

12) The method according to claim 8, wherein the density of the laundry serum composition is less than a laundry liquid with which it is used.

13) The method according to claim 8, wherein the laundry serum composition is not miscible with a laundry liquid with which it is used.

14) The method according to claim 8 wherein the laundry serum composition comprises a shading dye, antimicrobial agent or both.
